(19) United States
(12) Patent Application Publication
(10) Pub. No.: US 2026/0066662 A1
(43) Pub. Date: Mar. 5, 2026

(54) POWER SYSTEM, DC COUPLING DEVICE AND CONTROL METHOD THEREOF

(71) Applicant: Delta Electronics (Shanghai) Co., Ltd., Shanghai (CN)

(72) Inventors: Bo Feng, Shanghai (CN); Changyong Wang, Shanghai (CN); Yansong Lu, Shanghai (CN); Wei Huang, Shanghai (CN)

(21) Appl. No.: 19/312,504

(22) Filed: Aug. 28, 2025

(30) Foreign Application Priority Data
Aug. 30, 2024 (CN) 202411216926.4

(51) Int. Cl. H02J 3/38; H02J 3/00; H02J 3/28; H02J 7/00; H02S 10/20

(52) U.S. Cl. CPC H02J 3/38; H02J 3/0075; H02J 3/28; H02J 7/865; H02J 7/933; H02S 10/20; H02J 2101/24

(57) ABSTRACT

A power system and a control method of the power system are provided. The power system determines the operating mode according to the states and parameters of one or more of the power sources, the energy storage device and the hydrogen generation device. The power source and the corresponding power transmission path for hydrogen generation is selected. The selected power source supplies power. The selected power is converted and transmitted to provide the electric power required by the hydrogen generation device through the selected power transmission path. The selected optimal power source and the power transmission path supply power to the hydrogen generation device with stable, continuous, enhanced efficiency and reduced cost.

### CROSS-REFERENCE TO RELATED APPLICATION

This application claims priority to China Patent Application No. 202411216926.4, filed on Aug. 30, 2024, the entire contents of which are incorporated herein by reference for all purposes.

### FIELD OF THE INVENTION

The present disclosure relates to hydrogen generation, and more particularly to a power system about new energy, a DC coupling device and a control method of the power system.

### BACKGROUND OF THE INVENTION

Hydrogen energy accommodates large-scale and efficient renewable energy and redistributes energy across different industries and regions. Hydrogen energy is served as an energy buffer carrier to enhance the resilience of the energy system and reduce carbon emissions from transportation, industrial energy use and building heating. The original intention of hydrogen industry development is zero-carbon or low-carbon emissions. Consequently, hydrogen generation utilizing renewable energy will replace coal-based and natural gas-based hydrogen generation gradually.

At present, mainstream water electrolysis hydrogen generation equipment exhibits relatively slow dynamic response, so that the rapidly activation and load variation are difficult. Consequently, the hydrogen power supply providing stable power is required. However, renewable energy generation is intermittent and fluctuating so as to reduce the matching demand with hydrogen generation.

Therefore, there is a need of providing a power system, a DC coupling device and a control method of the power system in order to overcome the drawbacks of the conventional technologies.

### SUMMARY OF THE INVENTION

An object of the present disclosure is to provide a power system and a control method of the power system. The power system determines the operating mode according to the states and parameters of one or more of the power sources, the energy storage device and the hydrogen generation device. The power source and the corresponding power transmission path for hydrogen generation is selected. The selected power source supplies power. The selected power is converted and transmitted to provide the electric power required by the hydrogen generation device through the selected power transmission path. The selected optimal power source and the power transmission path supply power to the hydrogen generation device with stable, continuous, enhanced efficiency and reduced cost.

In accordance with an aspect of the present disclosure, a power system is provided. The power system supplies a hydrogen generation device. The power system includes a plurality of power sources, an energy storage device and a hydrogen generation power supply device. The hydrogen generation power supply device includes an AC terminal, a DC output terminal, a DC coupling terminal and a controller. The AC terminal is electrically connected with the plurality of power sources through an AC bus. The DC output terminal is electrically connected with the hydrogen generation device. The DC coupling terminal is electrically connected with the energy storage device. The controller determines an operating mode according to states and parameters of the plurality of power sources, the energy storage device and/or the hydrogen generation device. The controller selectively receives and converts an electric power provided by at least one of the plurality of power sources and/or the energy storage device, so as to supply power to the hydrogen generation device through at least one power transmission path. The hydrogen generation power supply device and/or the energy storage device provide the at least one power transmission path.

In accordance with another aspect of present disclosure, a DC coupling device is provided. The DC coupling device includes an energy storage device and a power supply device. The power supply device includes an AC terminal, a DC output terminal, a DC coupling terminal and a controller. The AC terminal is electrically connected with at least one power source through an AC bus. The DC output terminal is electrically connected with a power load. The DC coupling terminal is electrically connected with the energy storage device. The controller determines an operating mode according to states and parameters of the at least one power source, the energy storage device and/or the power load, and selectively receives and converts an electric power provided by the at least one power source and/or the energy storage device so as to supply power to the power load through at least one power transmission path. The power supply device and/or the energy storage device provide the at least one power transmission path.

In accordance with another aspect of present disclosure, a control method for a power system is provided. The power system supplies power to a hydrogen generation device. The control method includes the following steps. A plurality of power sources, an energy storage device and a hydrogen generation power supply device are provided. The hydrogen generation power supply device includes an AC terminal, a DC output terminal and a DC coupling terminal. The AC terminal is electrically connected with the plurality of power sources through an AC bus. The DC output terminal is electrically connected with the hydrogen generation device. The DC coupling terminal is electrically connected with the energy storage device. Then, an operating mode is determined according to states and parameters of the plurality of power sources, the energy storage device and/or the hydrogen generation device. An electric power provided by at least one of the plurality of power sources and/or the energy storage device is selectively received and converted so as to supply power to the hydrogen generation device through at least one power transmission path. The power supply device and/or the energy storage device provide the at least one power transmission path.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a schematic circuit diagram illustrating the power system of the present disclosure;

FIG. 2 is a schematic detailed circuit diagram illustrating of the power system according to a first embodiment of FIG. 1;

FIG. 3A illustrates an energy transmission path and a control block diagram of the power system of FIG. 2 when operating in a first power supply mode under an off-grid condition;

FIG. 3B illustrates an energy transmission path and a control block diagram of the power system of FIG. 2 when operating in a second power supply mode under the off-grid condition;

FIG. 3C illustrates an energy transmission path and a control block diagram of the power system of FIG. 2 when operating in a third power supply mode under the off-grid condition;

FIG. 3D illustrates an energy transmission path and a control block diagram of the power system of FIG. 2 when operating in a fourth power supply mode under the off-grid condition;

FIG. 3E illustrates an energy transmission path and a control block diagram of the power system of FIG. 2 when operating in a first power supply mode under a grid-connected condition;

FIG. 3F illustrates an energy transmission path and a control block diagram of the power system of FIG. 2 when operating in a second power supply mode under the grid-connected condition;

FIG. 3G illustrates an energy transmission path and a control block diagram of the power system of FIG. 2 when operating in a third power supply mode under the grid-connected condition;

FIG. 3H illustrates an energy transmission path and a control block diagram of the power system of FIG. 2 when operating in a fourth power supply mode under the grid-connected condition;

FIG. 4 is a schematic detailed circuit diagram illustrating of the power system according to a second embodiment of FIG. 1;

FIG. 5 is a schematic detailed circuit diagram illustrating of the power system according to a third embodiment of FIG. 1;

FIG. 6 is a schematic detailed circuit diagram illustrating of the power system according to a fourth embodiment of FIG. 1;

FIG. 7 is a schematic detailed circuit diagram illustrating of the power system according to a fifth embodiment of FIG. 1;

FIG. 8 is a schematic detailed circuit diagram illustrating of the power system according to a sixth embodiment of FIG. 1;

FIG. 9 is a schematic detailed circuit diagram illustrating of the power system according to a seventh embodiment of FIG. 1;

FIGS. 10A and 10B are flowcharts of a control method for a power system of the present disclosure; and

FIG. 11 illustrates a graph of the relationship between the power of the converter of the power supply applied to the power system of the present disclosure and the frequency of the AC bus.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

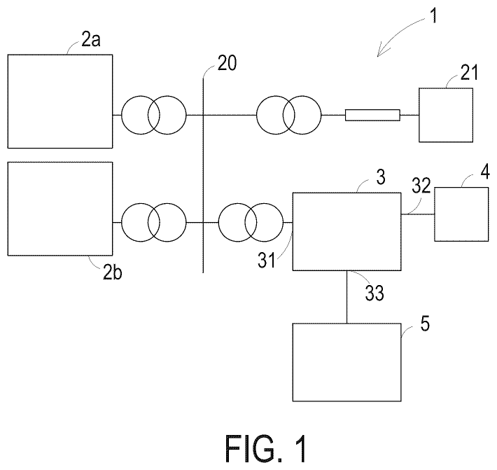

FIG. 1 is a schematic circuit diagram illustrating the power system of the present disclosure. As shown in FIG. 1, the power system 1 of the present disclosure supplies power to a hydrogen generation device 4. The power system 1 includes a plurality of power sources 21, 2a, and 2b, a hydrogen generation power supply device 3 and an energy storage device 5. The plurality of power sources 21, 2a, and 2b may include a power grid and a green energy power generation device. Preferably but not exclusively, the green energy power generation device is a wind power generation device, a photovoltaic power generation device and a fuel power generation device. The hydrogen generation power supply device 3 is electrically connected with the plurality of power sources 21, 2a, and 2b through an AC bus 20. The hydrogen generation power supply device 3 includes an AC terminal 31, a DC output terminal 32 and a DC coupling terminal 33. The AC terminal 31 is electrically connected with the AC bus 20. The DC output terminal 32 is electrically connected with the hydrogen generation device 4. The energy storage device 5 is electrically connected with the DC coupling terminal 33 of the hydrogen generation power supply device 3. The energy storage device 5 and the hydrogen generation power supply device 3 form a DC coupling device collaboratively. The hydrogen generation power supply device 3 selectively receives electric power provided by at least one of the plurality of power sources 21, 2a, and 2b and/or the energy storage device 5. The hydrogen generation power supply device 3 converts the electric power to a DC power for supplying the hydrogen generation device 4. Furthermore, the hydrogen generation power supply device 3 further includes a controller. The controller is electrically connected with the plurality of power sources 21, 2a, and 2b, the energy storage device 5 and the hydrogen generation device 4. The controller determines an operating mode to select the source of the electric power for producing hydrogen and determines a corresponding power transmission path according to at least one state and parameter of the plurality of power sources 21, 2a, and 2b, the energy storage device 5 and the hydrogen generation device 4. A plurality of power transmission paths are formed between the plurality of power sources 21, 2a, and 2b and the hydrogen generation device 4. Each power transmission path includes at least one power converter. The at least one power converter is configured to convert and transmit the electric power of the corresponding power transmission path. For example, the optimal power source is selected according to the state and parameters of the plurality of power sources 21, 2a, and 2b, the energy storage device 5 and the hydrogen generation device 4. The switch, the relay, or the power converter within the power transmission path is configured to select the power transmission path. The selected power source supplies power. The selected power is converted and transmitted to provide the electric power required by the hydrogen generation device 4 through the selected power transmission path. The selected optimal power source and the power transmission path supply power to the hydrogen generation device 4 with stable, continuous, enhanced efficiency and reduced cost.

The controller includes a mode selection unit and a plurality of power control units. The mode selection unit is electrically connected with the plurality of power sources and the hydrogen generation device. The mode selection unit is configured to receive a plurality of first parameters. The mode selection unit is configured to determine the power source for supplying power to the hydrogen generation device according to the first parameters and generate a plurality of power commands. Each power control unit is electrically connected with the mode selection unit, a corresponding power transmission path and a corresponding power converter. Each power control unit is configured to receive a plurality of second parameters and at least one power command outputted from the mode selection unit. Each power control unit is configured to control the corresponding power converter according to the plurality of second parameters and the power command. Consequently, the electric power is supplied to the hydrogen generation device through the corresponding power transmission path.

Furthermore, the selected optimal power source includes at least one power generation device and/or at least one energy storage device. The control method will be further described below.

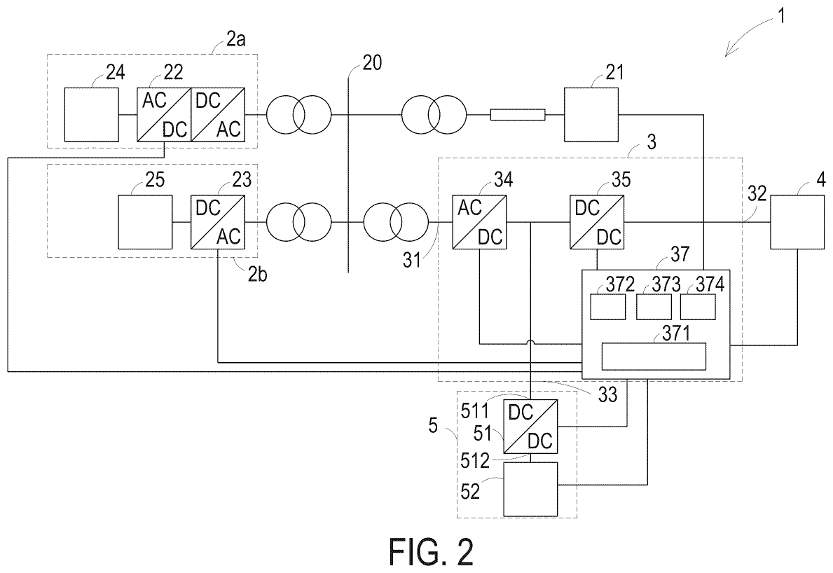

FIG. 2 is a schematic detailed circuit diagram illustrating of the power system according to a first embodiment of FIG. 1. As shown in FIG. 2, the power system 1 includes a power grid 21, a first power generation device 2a, a second power generation device 2b, an energy storage device 5 and a hydrogen generation power supply device 3. The hydrogen generation power supply device 3 is electrically connected with the power grid 21, the first power generation device 2a and the second power generation device 2b through an AC bus 20. The first power generation device 2a is but not limited to a wind power generation device and includes a wind generator 24 and a wind converter 22. The second power generation device 2b is but not limited to a photovoltaic power generation device and includes a photovoltaic panel 25 and a photovoltaic inverter 23.

The hydrogen generation power supply device 3 includes an AC/DC converter 34 and a DC/DC converter 35. The AC/DC converter 34 is but not limited to a PWM rectifier. An AC terminal of the AC/DC converter 34 is configured to form the AC terminal 31 of the hydrogen generation power supply device 3, or electrically connected with the AC terminal 31 of the hydrogen generation power supply device 3. A DC terminal of the AC/DC converter 34 is configured to form the DC coupling terminal 33 of the hydrogen generation power supply device 3, or electrically connected with the DC coupling terminal 33 of the hydrogen generation power supply device 3. An input terminal of the DC/DC converter 35 is electrically connected with the DC coupling terminal 33 of the hydrogen generation power supply device 3. An output terminal of the DC/DC converter 35 is configured to form the DC output terminal 32 of the hydrogen generation power supply device 3, or electrically connected with the DC output terminal 32 of the hydrogen generation power supply device 3. The energy storage device 5 includes an energy storage converter 51 and an energy storage element 52. The energy storage converter 51 is a full-power DC/DC converter or a partial-power DC/DC converter. For example, the energy storage converter 51 is a compensating-type DC/DC converter. Consequently, the cost of the DC/DC converter 35 is reduced. A first terminal 511 of the energy storage converter 51 is electrically connected with the DC coupling terminal 33 of the hydrogen generation power supply device 3. A second terminal 512 of the energy storage converter 51 is electrically connected with the energy storage element 52. The AC/DC converter 34, the DC/DC converter 35 and the energy storage converter 51 are coupled to the DC coupling terminal 33 collaboratively to form a DC bus. The AC/DC converter 34 and/or the energy storage converter 51 provides and stabilizes a DC bus voltage of the DC bus. The DC/DC converter 35 converts the DC bus voltage into an output voltage to supply power to the hydrogen generation device 4. The hydrogen generation device 4 is but not limited to an electrolyzer. The voltage required for an alkaline electrolyzer is between 300 V and 700 V. The voltage required for a PEM electrolyzer is up to 1500 V.

In an embodiment, the AC/DC converter 34, the DC/DC converter 35 and the energy storage converter 51 of the energy storage device 5 are located in the same housing (not shown). The energy storage element 52 of the energy storage device 5 is additionally disposed the exterior of the housing. Consequently, the AC/DC converter 34, the DC/DC converter 35 and the energy storage converter 51 form a three-port power device collaboratively. The AC terminal of the AC/DC converter 34 (i.e., the AC terminal 31 of the hydrogen generation power supply device 3) is served as a first power port of the three-port power device. The output terminal of the DC/DC converter 35 (i.e., the DC output terminal 32 of the hydrogen generation power supply device 3) is served as a second power port of the three-port power device. The second terminal 512 of the energy storage converter 51 is served as a third power port of the three-port power device. In another embodiment, the AC/DC converter 34, the DC/DC converter 35, the energy storage converter 51 and the energy storage element 52 are located inside the same housing. Consequently, the AC/DC converter 34, the DC/DC converter 35, the energy storage converter 51 and the energy storage element 52 form a two-port power device collaboratively. The AC terminal of the AC/DC converter 34 (i.e., the AC terminal 31 of the hydrogen generation power supply device 3) is served as a first power port of the two-port power device. The output terminal of the DC/DC converter 35 (i.e., the DC output terminal 32 of the hydrogen generation power supply device 3) is served as a second power port of the two-port power device. In another embodiment, the AC/DC converter 34 and the DC/DC converter 35 are located in one housing. The energy storage converter 51 and the energy storage element 52 of the energy storage device 5 are located in another housing. Consequently, the power conversion device formed by the AC/DC converter 34 and the DC/DC converter 35 is a three-port power device. The AC terminal of the AC/DC converter 34 (i.e., the AC terminal 31 of the hydrogen generation power supply device 3) is served as a first power port of the three-port power device. The output terminal of the DC/DC converter 35 (i.e., the DC output terminal 32 of the hydrogen generation power supply device 3) is served as a second power port of the three-port power device. The DC terminal of the AC/DC converter 34 is served as a third power port of the three-port power device. The energy storage converter 51 and the energy storage element 52 of the energy storage device 5 are mechanically coupled to the third power port of the hydrogen generation power supply device 3, i.e., the DC coupling terminal 33. In another embodiment, the AC/DC converter 34, the DC/DC converter 35 and the energy storage converter 51 are independent power modules. The three independent power modules are mechanically connected at the DC coupling terminal 33. In an embodiment, the DC coupling terminal 33 may also be disposed within the DC/DC converter 35 or the energy storage converter 51. The hydrogen generation power supply device 3 and the energy storage device 5 of the present disclosure may adopt integrated power modules to facilitate unified energy management and communication, or may adopt discrete power modules to facilitate maintenance.

Please refer to FIG. 2 again. A plurality of power transmission paths are formed between the power grid 21, the first power generation device 2a, the second power generation device 2b, the energy storage device 5 and the hydrogen generation power supply device 3. Each power transmission path includes one or more power converters, switches, or relays. The hydrogen generation power supply device 3 selects an optimal power source and a power transmission path for supplying power to the hydrogen generation device 4 according to the state and parameters of one or more of the power grid 21, the first power generation device 2a, the second power generation device 2b, the hydrogen generation device 4 and the energy storage device 5.

Accordingly, the hydrogen generation power supply device 3 further includes a controller 37. The controller 37 is electrically connected with the power grid 21, the first power generation device 2a, the second power generation device 2b, the AC/DC converter 34, the DC/DC converter 35, the hydrogen generation device 4, the energy storage converter 51 and the energy storage element 52. The controller 37 determines an operating mode and a power source according to one or more first parameters, and outputs a plurality of power commands. The controller 37 outputs a plurality of control signals according to the plurality of power commands and a plurality of second parameters. The plurality of control signals is configured to control the plurality of power converters to select at least one power transmission path. One or more first parameters are one or more parameters provided by the plurality of power sources or the plurality of power loads. For example, one or more parameters are formed from the power grid 21, the first power generation device 2a, the second power generation device 2b, the hydrogen generation device 4 and/or the energy storage device 5. The plurality of second parameters are parameters in the power transmission paths, such as the AC bus voltage, the output voltage and the output current. In this embodiment, the DC/DC converter 35 of the hydrogen generation power supply device 3 and the energy storage converter 51 of the energy storage device 5 independently control the hydrogen generation device 4 and the energy storage device 5, respectively. Consequently, the control flexibility is improved, and multiple application scenarios are compatible.

In this embodiment, the controller 37 includes a mode selection unit 371, an AC/DC control unit 372, a DC/DC control unit 373 and an energy storage control unit 374. The mode selection unit 371 is electrically connected with the first power generation device 2a, the second power generation device 2b and the hydrogen generation device 4. The mode selection unit 371 is configured to receive an output power signal P_{wind} of the first power generation device 2a, an output power signal P_{Pv} of the second power generation device 2b and a state signal of the hydrogen generation device 4 (e.g., port voltage, current, cycle, temperature, pressure, etc.). The mode selection unit 371 further receives a grid signal of the power grid 21 and a hydrogen generation power command P_{EC}. The grid signal and the hydrogen generation power command P_{EC} are but not limited to be generated by the controller 37 or an upper-level controller. The grid signal may indicate a grid-connected state or an off-grid state of the power grid 21. From above, the output power signal P_{wind} of the first power generation device 2a, the output power signal P_{Pv} of the second power generation device 2b, the state signal of the hydrogen generation device 4, the grid signal and the hydrogen generation power command P_{EC} may all be regarded as first parameters. The mode selection unit 371 outputs a plurality of power commands according to one or more of the first parameters. For example, the power commands include a DC bus voltage command V_{bus_ref}, a current command I_{o_ref} or a power command P_{o_ref}. Consequently, the controller 37 performs energy scheduling of the plurality of power sources and determines the control modes of the plurality of power converters in the power transmission paths through the plurality of power commands, and will be described below. The AC/DC control unit 372 is electrically connected with the mode selection unit 371, the AC terminal (i.e., the AC terminal 31 of the hydrogen generation power supply device 3) and the DC terminal (i.e., the DC coupling terminal 33 of the hydrogen generation power supply device 3) of the AC/DC converter 34. The AC/DC control unit 372 receives at least one power command, such as the DC bus voltage command V_{bus_ref}. The AC/DC control unit 372 further receives the AC voltage V_{abc} at the AC terminal 31, the AC current I_{abc}, the DC bus voltage V_{bus} in the DC coupling terminal 33. The AC/DC control unit 372 outputs a first control signal to control the AC/DC converter 34. The first control signal is but not limited to a first PWM signal. Consequently, the AC/DC control unit 372 outputs the first PWM signal to control the AC/DC converter 34 according to the DC bus voltage command V_{bus_ref} provided by the mode selection unit 371 and the relevant parameters of the AC/DC converter 34, so as to stabilize the DC bus voltage V_{bus}. The DC/DC control unit 373 is electrically connected with the mode selection unit 371 and the output terminal (i.e., the DC output terminal 32 of the hydrogen generation power supply device 3) of the DC/DC converter 35. The DC/DC control unit 373 receives at least one power command, such as the output current command I_{o_ref}. The DC/DC control unit 373 further receives the output voltage Vₒ and the output current Iₒ in the DC output terminal 32. The DC/DC control unit 373 outputs a second control signal to control the DC/DC converter 35. The second control signal is but not limited to a second PWM signal. Consequently, the DC/DC control unit 373 outputs the second PWM signal to control the DC/DC converter 35 according to the output current command I_{o_ref} provided by the mode selection unit 371 and the relevant parameters of the DC/DC converter 35, so as to control the output current Iₒ. The energy storage control unit 374 is electrically connected with the energy storage element 52 and the second terminal 512 of the energy storage converter 51. The energy storage control unit 374 receives the voltage I_{b} and the current V_{b} of the energy storage element 52 and the DC bus voltage V_{bus} in the DC coupling terminal 33. The energy storage control unit 374 outputs a third control signal to control the energy storage converter 51. The third control signal is but not limited to a third PWM signal. Consequently, the energy storage control unit 374 outputs the third PWM signal to control the charge current and the discharge current of the energy storage converter 51 according to the relevant parameters of the energy storage element 52 and the energy storage converter 51.

In another embodiment, the energy storage control unit 374 is electrically connected with the mode selection unit 371, the energy storage element 52 and the second terminal 512 of the energy storage converter 51. The energy storage control unit 374 receives at least one power command, such as the DC bus voltage command V_{bus} ref, the voltage I_{b} and the current V_{b} of the energy storage element 52 and the bus voltage V_{bus}. The energy storage control unit 374 outputs a third control signal to control the energy storage converter 51. The third control signal is but not limited to a third PWM signal. The energy storage control unit 374 outputs the third PWM signal to control the charge voltage and the discharge voltage of the energy storage converter 51 according to the DC bus voltage command V_{bus_ref}, the relevant parameters of the energy storage element 52, and the energy storage converter 51, so as to stabilize the DC bus voltage V_{bus}. Consequently, the AC/DC converter 34 does not need to stabilize the bus voltage V_{bus} in the DC coupling terminal 33.

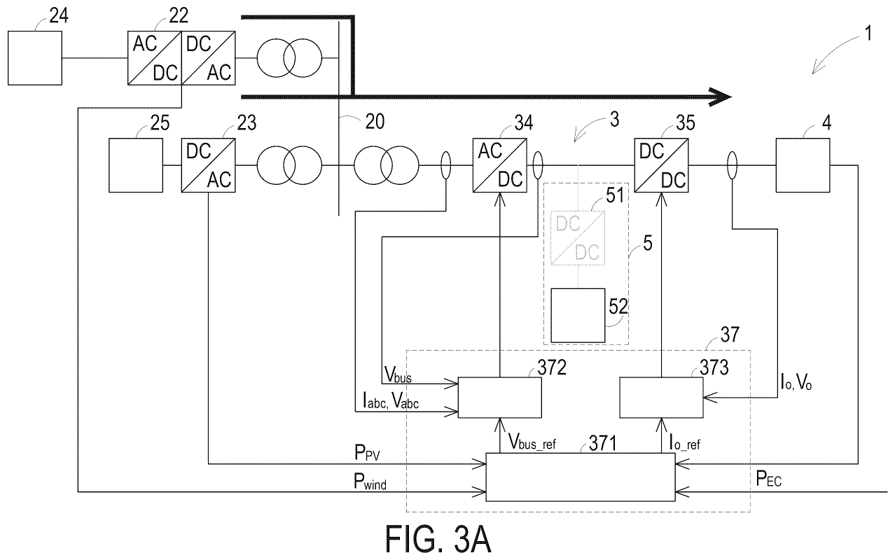

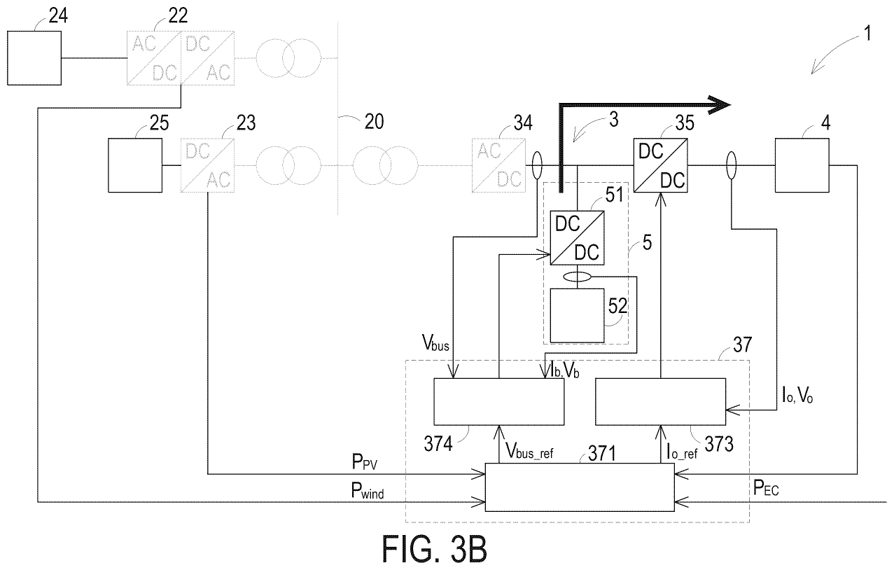

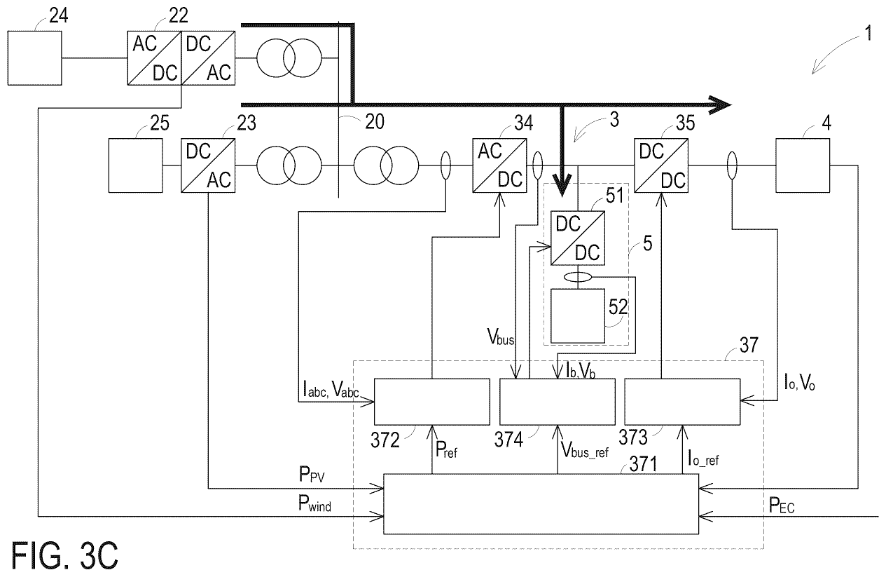

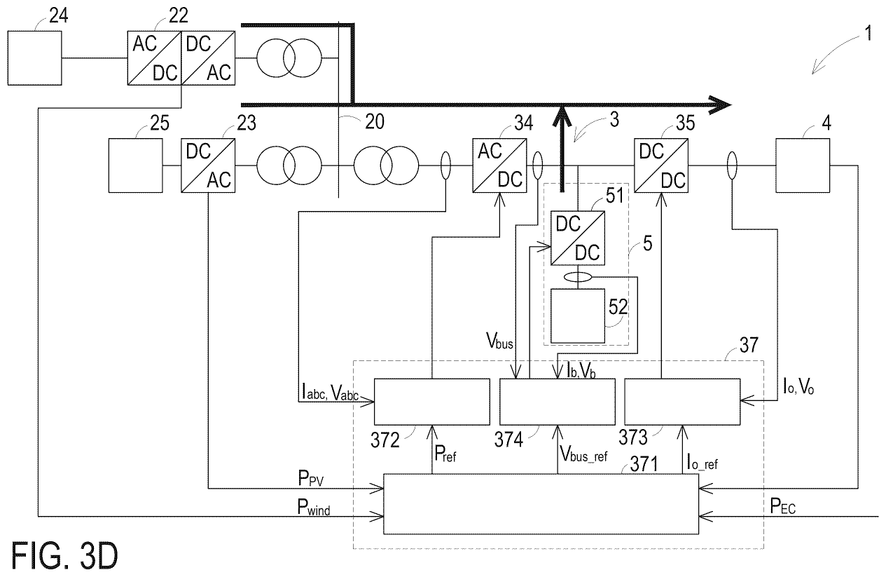

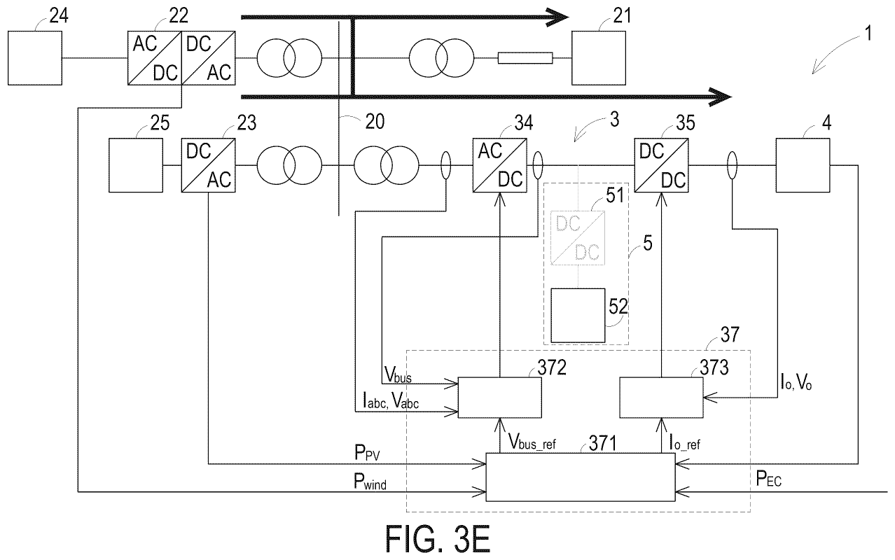

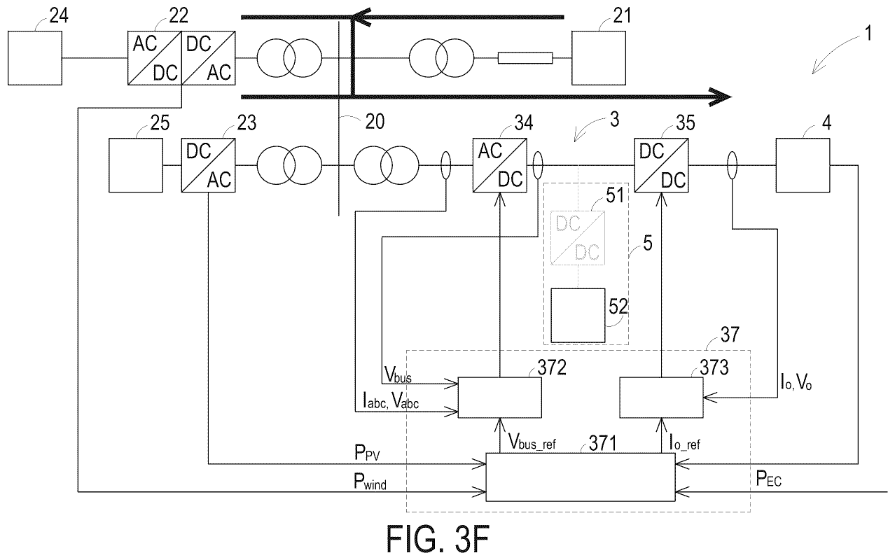

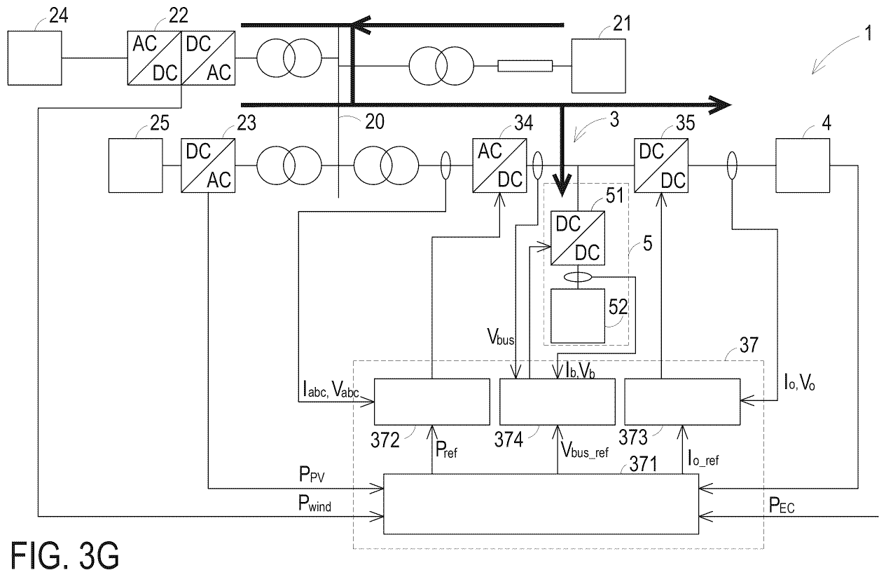

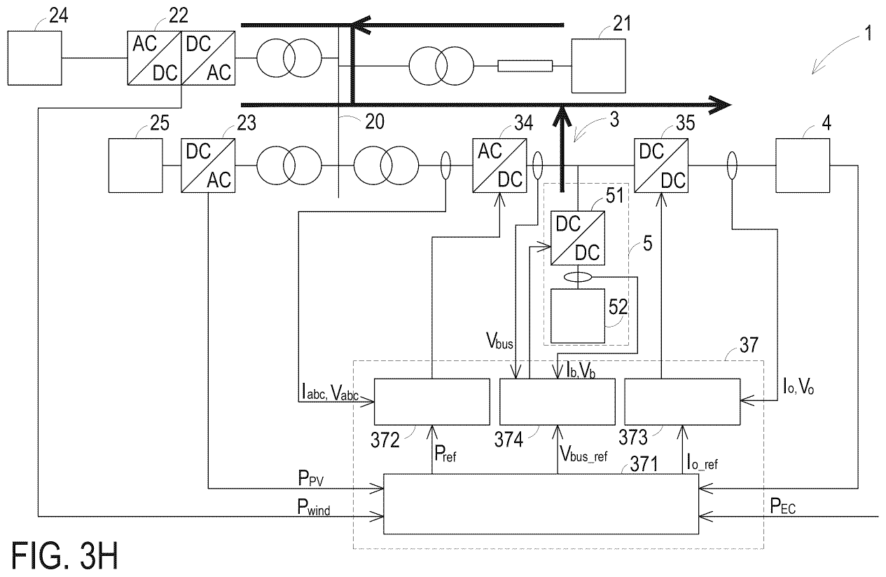

The control method of the controller 37 and the corresponding power transmission paths will be described below for different operating modes. FIG. 3A illustrates an energy transmission path and a control block diagram of the power system of FIG. 2 when operating in a first power supply mode under an off-grid condition. As shown in FIGS. 2 and 3A, the mode selection unit 371 determines the state of the power grid 21 according to the grid signal, and confirms that the power grid 21 is not connected with the AC bus 20 (i.e., under an off-grid condition). Then, the mode selection unit 371 compares the total output power of the first power generation device 2a and the second power generation device 2b (i.e., P_{green}=Pₚᵥ+P_{wind}) with the hydrogen generation power command P_{EC}. When the total output power P_{green} equaled to the hydrogen generation power command P_{EC} is confirmed, the mode selection unit 371 selects both the first power generation device 2a and the second power generation device 2b to supply power to the hydrogen generation device 4. The AC/DC control unit 372 outputs a first control signal to control the AC/DC converter 34 to perform high-frequency switching according to the DC bus voltage command V_{bus_ref} provided by the mode selection unit 371, the AC voltage V_{abc}, the AC current I_{abc} in the AC terminal of the AC/DC converter 34 and the bus voltage V_{bus}. Consequently, the AC/DC converter 34 receives the AC power provided by the first power generation device 2a and the second power generation device 2b. The AC/DC converter 34 converts the AC power to a DC power for supply to the DC/DC converter 35. Meanwhile, the bus voltage V_{bus} in the DC coupling terminal 33 between the AC/DC converter 34 and the DC/DC converter 35 is stabilized. The DC/DC control unit 373 outputs a second control signal to control the DC/DC converter 35 to perform high-frequency switching according to the output current command I_{o_ref} provided by the mode selection unit 371, the output voltage Vₒ and output current Iₒ of the DC/DC converter 35. Consequently, the DC/DC converter 35 receives the DC power provided by the AC/DC converter 34 and converts the DC power into DC output power to supply the hydrogen generation device 4. When the power system 1 is in the off-grid state with favorable wind and sunlight conditions, and the total output power P_{green} from the first power generation device 2a and the second power generation device 2b is equal to the hydrogen generation power command P_{EC}, the controller 37 selects the first power generation device 2a and the second power generation device 2b to supply power to the hydrogen generation device 4. The controller 37 selects the power transmission path formed by the AC/DC converter 34 and the DC/DC converter 35 to deliver the electric power provided from the first power generation device 2a and the second power generation device 2b to the hydrogen generation device 4. Consequently, the green hydrogen generation is achieved. Meanwhile, the energy storage device 5 does not participate in power conversion or transmission. For sampling the figure, the storage control unit 374 is omitted in FIG. 3A. As shown in FIG. 3A, in the first power supply mode under the off-grid condition, the electrical power generated by renewable energy sources (i.e., the first power generation device 2a and the second power generation device 2b) is directly supplied to the hydrogen generation device 4 for hydrogen generation. Consequently, the required power for the hydrogen generation device 4 is provided.

FIG. 3B illustrates an energy transmission path and a control block diagram of the power system of FIG. 2 when operating in a second power supply mode under the off-grid condition. As shown in FIGS. 2 and 3B, the mode selection unit 371 determines the state of the grid 21 according to the grid signal, and confirms that the grid 21 is not connected with the AC bus 20 (i.e., under an off-grid condition). Then, the mode selection unit 371 compares the total output power of the first power generation device 2a and the second power generation device 2b (i.e., P_{green}=P_{Pv}+P_{wind}) with the hydrogen generation power command P_{EC}. The mode selection unit 371 confirms that the total output power P_{green} is less than the hydrogen generation power command P_{EC}, and further confirms that the total output power P_{green} is equal to 0, the mode selection unit 371 only select the energy storage device 5 to supply power to the hydrogen generation device 4. The energy storage control unit 374 outputs a first control signal according to the DC bus voltage command V_{bus_ref} provided by the mode selection unit 371, the bus voltage V_{bus} in the DC terminal of the AC/DC converter 34 and the voltage I_{b} and the current V_{b} of the energy storage element 52, so as to control the energy storage converter 51 to perform high-frequency switching. Consequently, the energy storage converter 51 receives the DC power provided by the energy storage element 52. The DC power is converted to the DC/DC converter 35. The bus voltage V_{bus} of the DC coupling terminal 33 is stabilized. The DC/DC control unit 373 outputs a second control signal according to the output current command I_{o_ref} provided by the mode selection unit 371 and the output voltage Vₒ and the output current Iₒ of the DC/DC converter 35, so as to control the DC/DC converter 35 to perform high-frequency switching. Consequently, the DC/DC converter 35 receives the DC power provided by the energy storage converter 51. The DC power is converted to a DC output power. The DC output power is supplied to the hydrogen generation device 4. When the power provided by the first power generation device 2a and the second power generation device 2b is not suitable, the controller 37 selects the energy storage device 5 to supply power to the hydrogen generation device 4 and selects the power transmission path formed by the energy storage converter 51 and the DC/DC converter 35 to deliver the power of the energy storage element 52 to the hydrogen generation device 4 for hydrogen generation. Meanwhile, the AC/DC converter 34 does not participate in power conversion and transmission. For sampling the figure, the AC/DC control unit 372 is omitted in FIG. 3B. As shown in FIG. 3B, in the second power supply mode under the off-grid condition, all the power generated by the energy storage device 5 is supplied to the hydrogen generation device 4 for hydrogen generation. Consequently, the required power for the hydrogen generation device 4 is provided.

FIG. 3C illustrates an energy transmission path and a control block diagram of the power system of FIG. 2 when operating in a third power supply mode under the off-grid condition. As shown in FIGS. 2 and 3C, the mode selection unit 371 determines the state of the grid 21 according to the grid signal, and confirms that the grid 21 is not connected with the AC bus 20 (i.e., under an off-grid condition). Then, the mode selection unit 371 compares the total output power of the first power generation device 2a and the second power generation device 2b (i.e., P_{green}=P_{Pv}+P_{wind}) with the hydrogen generation power command P_{EC}. The mode selection unit 371 confirms that the total output power P_{green} is greater than the hydrogen generation power command P_{EC}, and the first power generation device 2a and the second power generation device 2b are selected to simultaneously supply power to the hydrogen generation device 4 and the energy storage device 5. The AC/DC control unit 372 outputs a first control signal according to the power command P_{ref} provided by the mode selection unit 371 and the AC voltage V_{abc}, the AC current I_{abc} in the AC terminal of the AC/DC converter 34 and the bus voltage V_{bus}, so as to control the AC/DC converter 34 to perform high-frequency switching. Consequently, the AC/DC converter 34 receives the AC power provided by the first power generation device 2a and the second power generation device 2b and converts the AC power to a DC power. The DC power is supplied to both the DC/DC converter 35 and the energy storage converter 51. Consequently, the AC-side power of the AC/DC converter 34 is stabilized. The DC/DC control unit 373 outputs a second control signal according to the output current command I_{o_ref} provided by the mode selection unit 371, the output voltage Vₒ and output current Iₒ of the DC/DC converter 35, so as to control the DC/DC converter 35 to perform high-frequency switching. Consequently, the DC/DC converter 35 receives the DC power provided by the AC/DC converter 34 and converts the DC power into a DC output power to supply the hydrogen generation device 4. The energy storage control unit 374 outputs a third control signal according to the DC bus voltage command V_{bus_ref} provided by the mode selection unit 371, the bus voltage V_{bus} in the DC terminal of the AC/DC converter 34, the voltage I_{b} and the current V_{b} of the energy storage element 52, so as to control the energy storage converter 51 to perform high-frequency switching. Consequently, the energy storage converter 51 receives and converts the DC power provided by the AC/DC converter 34 to supply to the energy storage element 52. Consequently, the bus voltage V_{bus} of the DC coupling terminal 33 is stabilized. When the power system 1 is under the off-grid condition with favorable wind and solar conditions, and the total output power P_{green} from the first power generation device 2a and the second power generation device 2b is greater than the hydrogen generation power command P_{EC}, the controller 37 selects the first power generation device 2a and the second power generation device 2b to simultaneously supply power to the hydrogen generation device 4 and the energy storage device 5. The controller 37 selects a first power transmission path formed by the AC/DC converter 34 and the DC/DC converter 35 to deliver the power from the first power generation device 2a and the second power generation device 2b to the hydrogen generation device 4. The controller 37 selects a second power transmission path formed by the AC/DC converter 34 and the energy storage converter 51 to deliver the power from the first power generation device 2a and the second power generation device 2b to the energy storage device 5. Consequently, the green hydrogen generation is achieved, and the energy storage element 52 is charged. As shown in FIG. 3C, in the third power supply mode under the off-grid condition, the electrical power generated by renewable energy sources (i.e., the first power generation device 2a and the second power generation device 2b) is configured to supply power to the hydrogen generation device 4 for hydrogen generation and charge the energy storage element 52.

In another embodiment, if the energy storage device 5 is not permitted to be charged, the power generation system 1 in the third power supply mode under the off-grid condition may further limit the output power of the first power generation device 2a and the second power generation device 2b so as to match the power demand of the hydrogen generation device 4.

FIG. 3D illustrates an energy transmission path and a control block diagram of the power system of FIG. 2 when operating in a fourth power supply mode under the off-grid condition. As shown in FIGS. 2 and 3D, the mode selection unit 371 determines the state of the power grid 21 according to a grid signal and confirms that the power grid 21 is not connected with the AC bus 20 (i.e., under an off-grid condition). Then, the mode selection unit 371 compares the total output power of the first power generation device 2a and the second power generation device 2b (i.e., P_{green}=Pₚᵥ+P_{wind}) with the hydrogen generation power command P_{EC}. The mode selection unit 371 confirms that the total output power P_{green} is less than the hydrogen generation power command P_{EC} and the total output power P_{green} is greater than 0, the mode selection unit 371 selects the first power generation device 2a, the second power generation device 2b and the energy storage device 5 to supply power to the hydrogen generation device 4. The AC/DC control unit 372 outputs a first control signal according to the power command P_{ref} provided by the mode selection unit 371 and the AC voltage V_{abc} and the AC current I_{abc} in the AC terminal of the AC/DC converter 34 to control the AC/DC converter 34 to perform high-frequency switching. Consequently, the AC/DC converter 34 receives the AC power provided by the first power generation device 2a and the second power generation device 2b and converts the AC power to a DC power to supply the DC/DC converter 35. The AC-side power of the AC/DC converter 34 is controlled. The energy storage control unit 374 outputs a third control signal according to the DC bus voltage command V_{bus_ref} provided by the mode selection unit 371, the DC bus voltage V_{bus} in the DC terminal of the AC/DC converter 34, the voltage I_{b} and the current V_{b} of the energy storage element 52 to control the energy storage converter 51 to perform high-frequency switching. Consequently, the energy storage converter 51 receives and converts the DC power provided by the energy storage element 52 to supply the DC/DC converter 35. The DC bus voltage V_{bus} in the DC coupling terminal 33 is stabilized. The DC/DC control unit 373 outputs a second control signal according to the output current command I_{o_ref} provided by the mode selection unit 371, the output voltage Vₒ and the output current Iₒ of the DC/DC converter 35 to control the DC/DC converter 35 to perform high-frequency switching. Consequently, the DC/DC converter 35 receives and converts DC power provided by both the AC/DC converter 34 and the energy storage converter 51 to output a DC power to supply the hydrogen generation device 4. When the power system 1 is under the off-grid condition with relatively weak wind and solar conditions that cannot meet the hydrogen requirement, and the total output power P_{green} of the first power generation device 2a and the second power generation device 2b is less than the hydrogen generation power command P_{EC} but greater than 0, the controller 37 selects the first power generation device 2a, the second power generation device 2b and the energy storage device 5 to simultaneously supply power to the hydrogen generation device 4. The controller 37 selects a first energy transmission path formed by the AC/DC converter 34 and the DC/DC converter 35 to deliver power from the first power generation device 2a and the second power generation device 2b to the hydrogen generation device 4. The controller 37 selects a second energy transmission path formed by the energy storage device 5 and the DC/DC converter 35 to deliver power from the energy storage device 5 to the hydrogen generation device 4. As shown in FIG. 3D, in the fourth power supply mode under the off-grid condition, the electric power generated by the renewable energy sources (i.e., the first power generation device 2a and the second power generation device 2b) and the energy storage device 5 is configured to supply the hydrogen generation device 4 for hydrogen generation. Consequently, the required power for the hydrogen generation device 4 is provided.

FIG. 3E illustrates an energy transmission path and a control block diagram of the power system of FIG. 2 when operating in a first power supply mode under a grid-connected condition. As shown in FIGS. 2 and 3E, the mode selection unit 371 determines the state of the power grid 21 according to the grid signal and confirms that the power grid 21 is connected with the AC bus 20 (i.e., under the grid-connected condition). Then, the mode selection unit 371 compares the total output power of the first power generation device 2a and the second power generation device 2b (i.e., P_{green}=Pₚᵥ+P_{wind}) with the hydrogen generation power command P_{EC}, confirms that the total output power P_{green} is greater than the hydrogen generation power command P_{EC}, and further confirms that the energy storage device 5 does not allow be charged. The mode selection unit 371 selects the first power generation device 2a and the second power generation device 2b to supply power simultaneously to both the hydrogen generation device 4 and the power grid 21. Meanwhile, the power of the AC terminal of the AC/DC converter 34 is the total output power of the first power generation device 2a and the second power generation device 2b (i.e., P_{green}=Pₚᵥ+P_{wind}) minus the power supplied to the power grid 21. The power transmission path and the control method for supplying power to the hydrogen generation device 4 are similar to those shown in FIG. 3A, and are not redundantly described hereinafter. When the power system 1 is in the grid-connected state with favorable wind and solar conditions, the total output power P_{green} of the first power generation device 2a and the second power generation device 2b is greater than the hydrogen generation power command P_{EC}, and the energy storage device 5 does not allow be charged, the controller 37 selects the first power generation device 2a and the second power generation device 2b to supply power simultaneously to both the hydrogen generation device 4 and the power grid 21. Meanwhile, the energy storage device 5 does not participate in power conversion and transmission. For sampling the figure, the energy storage control unit 374 is omitted in FIG. 3E. As shown in FIG. 3E, in the first power supply mode under the grid-connected condition, the electrical energy generated by the renewable energy sources (i.e., the first power generation device 2a and the second power generation device 2b) is configured to supply power to the hydrogen generation device 4 for hydrogen generation. Consequently, the required power for the hydrogen generation device 4 is provided, and the power grid 21 is charged simultaneously.

FIG. 3F illustrates an energy transmission path and a control block diagram of the power system of FIG. 2 when operating in a second power supply mode under the grid-connected condition. As shown in FIGS. 2 and 3F, the mode selection unit 371 determines the state of the power grid 21 according to the grid signal and confirms that the power grid 21 is connected with the AC bus 20 (i.e., under the grid-connected condition). Then, the mode selection unit 371 compares the total output power of the first power generation device 2a and the second power generation device 2b (i.e., P_{green}=Pₚᵥ+P_{wind}) with the hydrogen generation power command P_{EC}, and confirms that the total output power P_{green} is less than the hydrogen generation power command P_{EC}, and the energy storage device 5 is not allowed to be discharged, the mode selection unit 371 selects the first power generation device 2a, the second power generation device 2b and the power grid 21 to simultaneously supply power to the hydrogen generation device 4. Meanwhile, the power of the AC terminal of the AC/DC converter 34 is equal to the total output power of the first power generation device 2a and the second power generation device 2b (i.e., P_{green}=Pₚᵥ+P_{wind}) plus the power provided by the power grid 21. The power transmission path and the control method for supplying power to the hydrogen generation device 4 are similar to those shown in FIG. 3A, are not redundantly described hereinafter. When the power system 1 is in the grid-connected state with relatively weak wind and solar conditions that cannot meet the hydrogen requirement, the total output power P_{green} of the first power generation device 2a and the second power generation device 2b is less than the hydrogen generation power command P_{EC}, and the energy storage device 5 is not allowed to be discharged, the controller 37 selects the first power generation device 2a, the second power generation device 2b and the power grid 21 to simultaneously supply power to the hydrogen generation device 4. Meanwhile, the energy storage device 5 does not participate in power conversion and transmission. For sampling the figure, the energy storage control unit 374 is omitted in FIG. 3F. As shown in FIG. 3F, in the second power supply mode under the grid-connected condition, the electrical energy generated by the renewable energy sources (i.e., the first power generation device 2a and the second power generation device 2b) and the electrical energy of the power grid 21 are configured to supply power to the hydrogen generation device 4 for hydrogen generation. Consequently, the required power for the hydrogen generation device 4 is provided.

FIG. 3G illustrates an energy transmission path and a control block diagram of the power system of FIG. 2 when operating in a third power supply mode under the grid-connected condition. As shown in FIGS. 2 and 3G, the mode selection unit 371 determines the state of the power grid 21 according to the grid signal and confirms that the power grid 21 is connected with the AC bus 20 (i.e., under the grid-connected state). Then, the mode selection unit 371 compares the total output power of the first power generation device 2a and the second power generation device 2b (i.e., P_{green}=Pₚᵥ+P_{wind}) with the hydrogen generation power command P_{EC}, confirms that the total output power P_{green} is greater than the hydrogen generation power command P_{EC}, and further confirms that the energy storage device 5 is allowed to be charged, the first power generation device 2a, the second power generation device 2b and the grid 21 are selected to simultaneously supply power to both the hydrogen generation device 4 and the energy storage device 5. The power transmission path and the control method for supplying power to the hydrogen generation device 4 are similar to those shown in FIG. 3C, and are not redundantly described hereinafter. When in the grid-connected state with the favorable wind and solar conditions, and the total power output P_{green} of the first power generation device 2a and the second power generation device 2b is greater than the hydrogen generation power command P_{EC}, and the energy storage device 5 is allowed to be charged, the controller 37 selects the first power generation device 2a, the second power generation device 2b and the grid 21 to simultaneously supply power to the hydrogen generation device 4 and the energy storage device 5. As shown in FIG. 3G, in the third power supply mode under the grid-connected condition, the electric power generated by renewable energy sources (i.e., the first power generation device 2a and the second power generation device 2b) and the electric power provided by the power grid 21 simultaneously supply power to the hydrogen generation device 4 for hydrogen generation. Consequently, the required power for the hydrogen generation device 4 is provided, and the energy storage device 5 is charged simultaneously.

In another embodiment, when the electricity price of the power grid 21 is enhanced, or during peak power consumption periods, or when it is desired to achieve green hydrogen generation, and the power system 1 is in the third power supply mode under the grid-connected condition, the power grid 21 does not participate in supplying power. Alternatively, the electrical energy generated by the first power generation device 2a and the second power generation device 2b may be simultaneously supplied to the power grid 21 to accomplish grid-connected power generation.

FIG. 3H illustrates an energy transmission path and a control block diagram of the power system of FIG. 2 when operating in a fourth power supply mode under the grid-connected condition. As shown in FIGS. 2 and 3H,

the mode selection unit 371 determines the state of the power grid 21 according to the grid signal and confirms that the power grid 21 is connected with the AC bus 20 (i.e., under the grid-connected condition). Then, the mode selection unit 371 compares the total output power of the first power generation device 2a and the second power generation device 2b (i.e., P_{green}=Pₚᵥ+P_{wind}) with the hydrogen generation power command P_{EC}, and when the total output power P_{green} is less than the hydrogen generation power command P_{EC} and the energy storage device 5 is allowed to be discharged, the first power generation device 2a, the second power generation device 2b, the power grid 21 and the energy storage device 5 are selected to simultaneously supply power to the hydrogen generation device 4. The power transmission path and the control method for supplying power to the hydrogen generation device 4 are similar to those shown in FIG. 3D, and are not redundantly described hereinafter. When the power system 1 is under the grid-connected condition and the wind and solar conditions do not satisfy the hydrogen generation demand, the total output power P_{green} of the first power generation device 2a and the second power generation device 2b is less than the hydrogen generation power command P_{EC}, and when the energy storage device 5 is allowed to be discharged, the controller 37 selects the first power generation device 2a, the second power generation device 2b, the power grid 21 and the energy storage device 5 to simultaneously supply power to the hydrogen generation device 4. As shown in FIG. 3G, in the fourth power supply mode under the grid-connected condition, the electrical energy generated by the renewable energy sources (i.e., the first power generation device 2a and the second power generation device 2b), the electrical energy supplied by the power grid 21 and the electrical energy provided by the energy storage device 5 are simultaneously configured to supply the hydrogen generation device 4 for hydrogen generation. Consequently, the required power for the hydrogen generation device 4 is provided.

In some embodiments, the energy storage element 52 in FIG. 2 may also be a photovoltaic panel. Meanwhile, only a discharging mode is formed between the energy storage device 5 and the hydrogen generation device 3, and any charging mode is not existed.

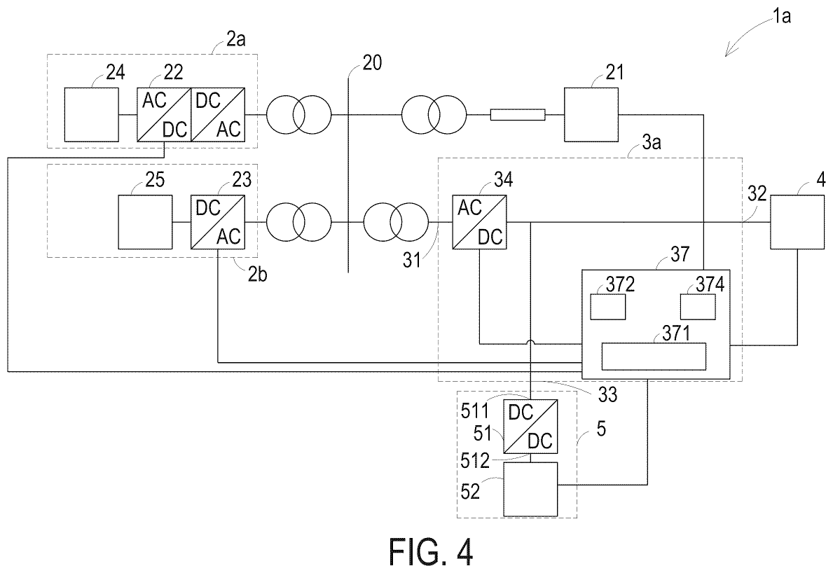

FIG. 4 is a schematic detailed circuit diagram illustrating of the power system according to a second embodiment of FIG. 1. The hydrogen generation power supply device 3 of the power system 1 of FIG. 2 includes an AC/DC converter 34 and a DC/DC converter 35. As shown in FIG. 4, compared with the power system 1 of FIG. 2, the hydrogen generation power supply device 3a of the power system 1a of this embodiment only includes an AC/DC converter 34. The AC/DC converter 34 of the hydrogen generation power supply device 3a and the energy storage converter 51 of the energy storage device 5 are electrically connected with the hydrogen generation device 4, respectively. In this embodiment, the hydrogen generation power supply device 3a performs AC/DC conversion utilizing a single-stage converter. Consequently, the hydrogen generation efficiency is improved. Meanwhile, the controller 37 of this embodiment may omit the DC/DC control unit accordingly. Moreover, since the AC/DC converter 34 is a boost converter, the voltage of the DC terminal of the AC/DC converter 34 is greater than the voltage of the AC terminal of the AC/DC converter 34. However, when the hydrogen generation device 4 is activated, the voltage of the terminal is lower than the voltage of the DC terminal of the AC/DC converter 34. Consequently, the AC/DC converter 34 cannot be activated during the activated stage of the hydrogen generation device 4. Before the hydrogen generation device 4 is activated, the switch on the AC terminal or the DC terminal of the AC/DC converter 34 needs to be disconnected. The hydrogen generation device 4 is supplied by the energy storage element 52 through the energy storage converter 51, so as to gradually increase the current or the voltage of the hydrogen generation device 4. Once the voltage of the hydrogen generation device 4 reaches the minimum voltage of the AC/DC converter 34, the switches on the AC terminal and DC terminal of the AC/DC converter 34 are conducted. The control signals are adjusted to regulate the power at the AC terminal or the DC terminal of the AC/DC converter 34. The energy storage converter 51 controls the charging and discharging power of the energy storage element 52.

In this embodiment, different power supply modes of the hydrogen generation power supply device 3a of the power system 1a under the off-grid condition or the grid-connected condition are similar to the corresponding power supply modes of the hydrogen generation power supply device 3 of the power system 1 of FIGS. 3A to 3H under the off-grid condition or the grid-connected condition. Under different power supply modes of this embodiment, when the AC/DC converter 34 is activated, the AC/DC control unit 372 is configured to control the current or the power of the DC terminal and the AC terminal of the AC/DC converter 34. When the energy storage converter 51 is activated, the energy storage control unit 374 is configured to control the output current or the output power of the hydrogen generation power supply device 3.

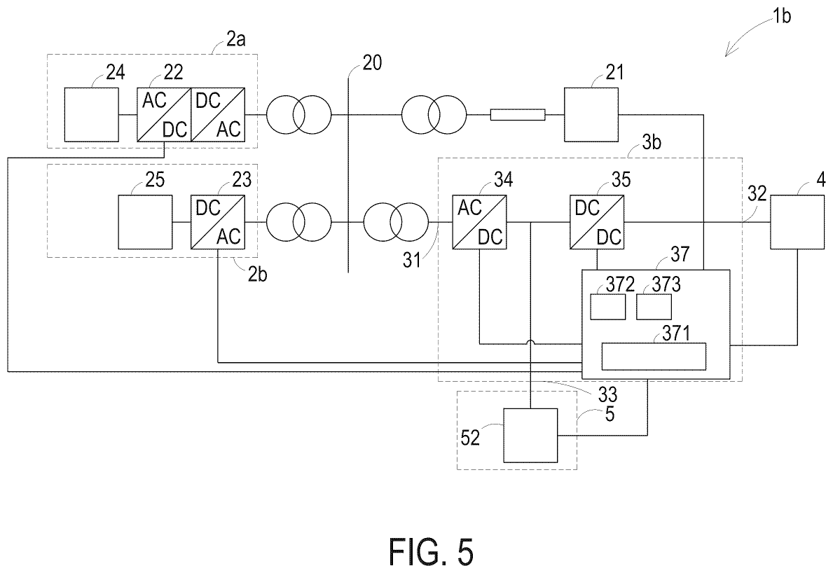

FIG. 5 is a schematic detailed circuit diagram illustrating of the power system according to a third embodiment of FIG. 1. The energy storage device 5 of the power system 1 of FIG. 2 includes an energy storage converter 51 and an energy storage element 52. As shown in FIG. 5, compared with the power system 1 of FIG. 2, the storage device 5 of the power system 1b of this embodiment only includes the energy storage element 52 without the energy storage converter. The energy storage element 52 of the energy storage device 5 is electrically connected with the connection wire between the AC/DC converter 34 and the DC/DC converter 35. Namely, the energy storage element 52 of the energy storage device 5 is electrically connected with the DC coupling terminal 33. The hydrogen generation power supply device 3b of this embodiment directly supports the bus voltage between the AC/DC converter 34 and the DC/DC converter 35 through the energy storage device 5. Consequently, the energy storage converter connected with the energy storage device 5 can be omitted. The controller 37 of this embodiment may omit the energy storage control unit accordingly.

In this embodiment, the hydrogen generation power supply device 3b of the power system 1b, under different power supply modes under either off-grid or grid-connected conditions, operates similarly to the corresponding power supply modes of the hydrogen generation power supply device 3 of the power system 1 as shown in FIGS. 3A to 3H. Under different power supply modes in this embodiment, when the AC/DC converter 34 is operating, the AC/DC control unit 372 is configured to control the power at the AC side or the bus voltage of the AC/DC converter 34; whereas when the DC/DC converter 35 is operating, the DC/DC control unit 373 is configured to control the output current or power of the hydrogen generation power supply device 3.

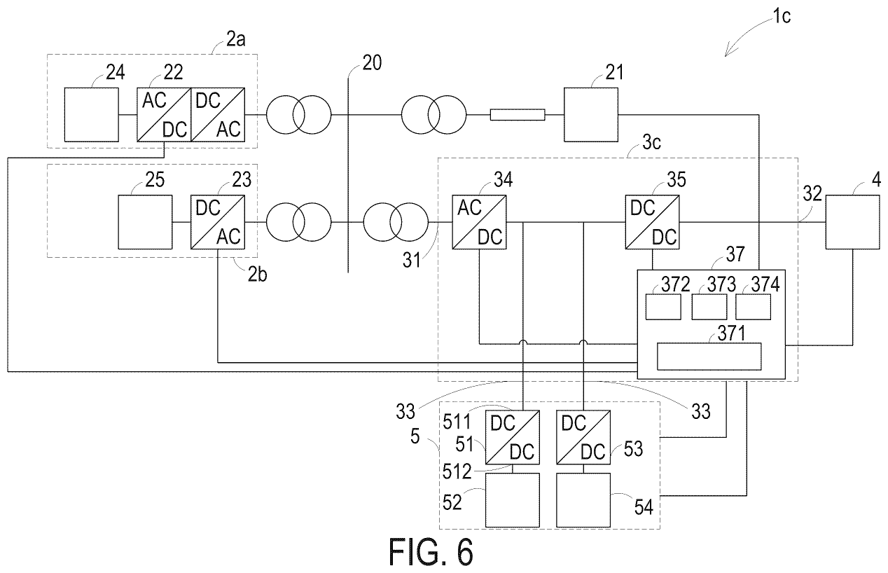

In some embodiments, the hydrogen generation power supply device and the energy storage device are mechanically attached to the DC terminal to form a DC-coupled hydrogen generation system. The DC-coupled hydrogen generation system may further integrate a DC photovoltaic power generation device to form a PV-storage-hydrogen multi-port energy network. FIG. 6 is a schematic detailed circuit diagram illustrating of the power system according to a fourth embodiment of FIG. 1. The energy storage device 5 of the power system 1 of FIG. 2 only includes a single energy storage converter 51 and a single energy storage element 52. Compared with the energy storage device 5 of the power system 1 of FIG. 2, the energy storage device 5 of the power system 1c of this embodiment further includes an additional energy storage converter (hereinafter, the original energy storage converter is referred to as the first energy storage converter 51, and the additional energy storage converter is referred to as the second energy storage converter 53) and an additional energy storage element (e.g., a second photovoltaic panel 54).

One end of the second energy storage converter 53 is electrically connected with the DC coupling terminal 33 of the hydrogen generation power supply device 3c. The other end of the second energy storage converter 53 is electrically connected with the second photovoltaic panel 54. The electric power provided by the second photovoltaic panel 54 can be transmitted to the DC coupling terminal 33 through the second energy storage converter 53. Consequently, the DC bus voltage is stabilized, or the hydrogen generation ability of the second photovoltaic panel 54 and the charging power of the energy storage device 5 are controlled.

In an embodiment, the electric power may be mutually supplied between the second photovoltaic panel 54 and the energy storage element 52. For example, under favorable sunlight condition during the day, the second photovoltaic panel 54 can provide unnecessary energy to charge the energy storage element 52 or transmit energy back to the power grid 21. Consequently, the energy demand from the energy storage element 52 and the power grid 21 during hydrogen generation are reduced. The service life of the energy storage element 52 is extended. The cost of purchasing electricity from the power grid 21 is reduced. Furthermore, the second photovoltaic panel 54 is used for generating hydrogen, the loss of the boost converter and the buck converter is reduced to improve the energy conversion efficiency. Consequently, the power system 1c of this embodiment is suitable for application in PV power plants utilizing the DC power grids, or in hydrogen generation stations for integrating the local PV.

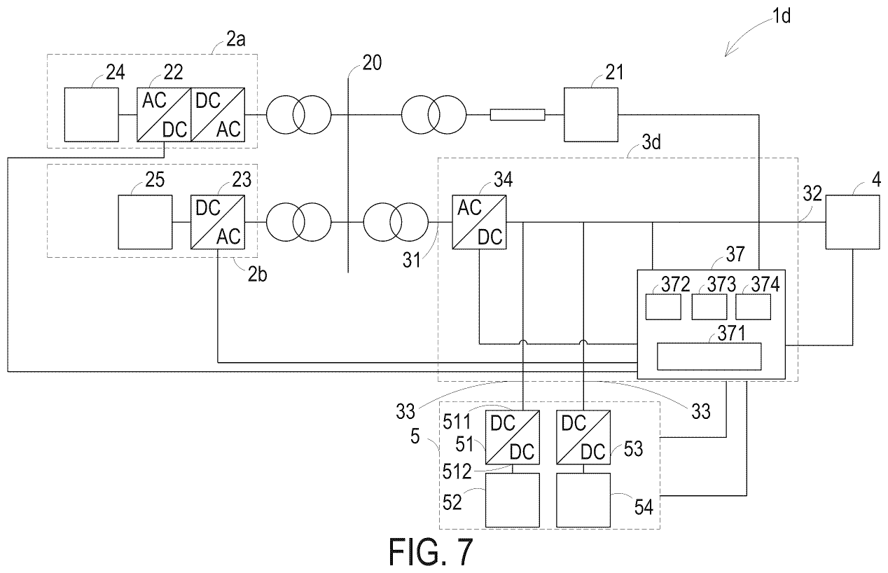

Certainly, the energy storage device of the above embodiments may also be applied to the power systems similar of FIG. 4. FIG. 7 is a schematic detailed circuit diagram illustrating of the power system according to a fifth embodiment of FIG. 1. Compared with the power system 1c of FIG. 6, the hydrogen generation power supply device 3d of the power system 1d of this embodiment only includes the AC/DC converter 34 without the DC/DC converter. Consequently, the AC/DC converter 34 of the hydrogen generation power supply device 3d and the energy storage converters 51 and 53 of the energy storage device 5 are electrically connected with the hydrogen generation device 4, respectively. The hydrogen generation power supply device 3d of this embodiment performs AC/DC conversion utilizing a single-stage converter. The hydrogen generation efficiency is improved. Accordingly, the controller 37 of this embodiment may omit the DC/DC control unit.

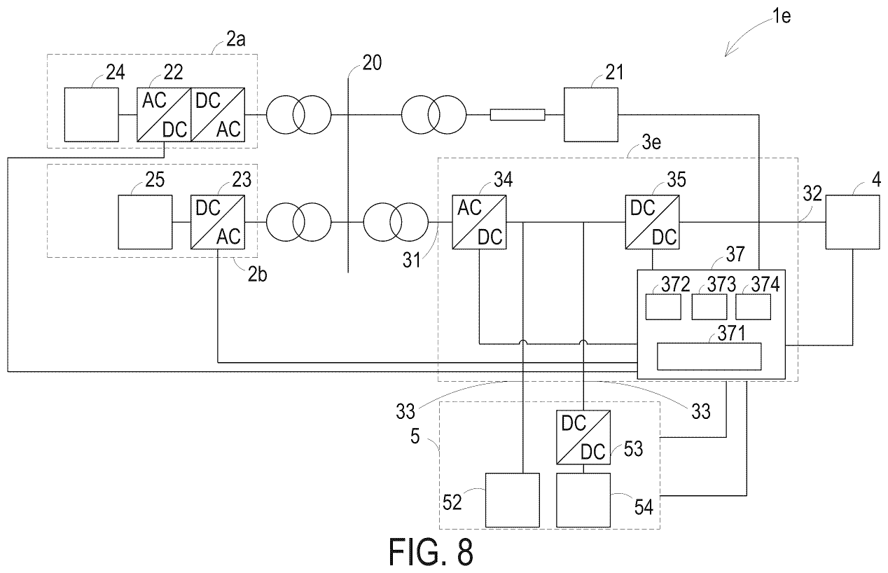

FIG. 8 is a schematic detailed circuit diagram illustrating of the power system according to a sixth embodiment of FIG. 1. As shown in FIG. 8, compared with the power system 1c of FIG. 6, the energy storage device 5 of the power system 1e of this embodiment only includes the energy storage element 52, the second energy storage converter 53 and the second photovoltaic panel 54. The energy storage device 5 of the power system 1e does not include the first energy storage converter. Namely, the energy storage element 52 can be directly connected with the DC coupling terminal 33 of the hydrogen generation power supply device 3.

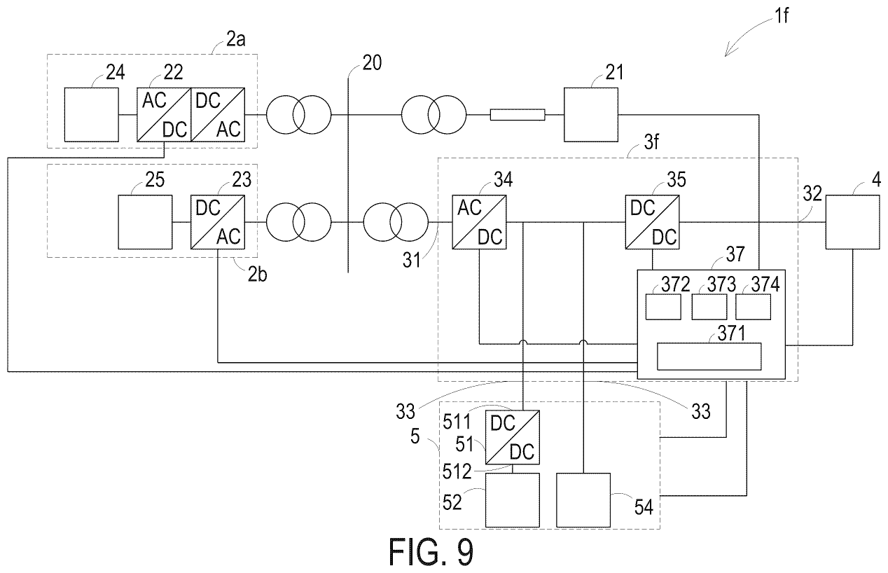

FIG. 9 is a schematic detailed circuit diagram illustrating of the power system according to a seventh embodiment of FIG. 1. The energy storage device 5 of the power system 1 of FIG. 2 only includes a single energy storage converter 51 and a single energy storage element 52. As shown in FIG. 9, compared with the energy storage device 5 of the power system 1 of FIG. 2, the energy storage device 5 of the power system 1f of this embodiment further includes an additional photovoltaic panel (hereinafter referred to as the second photovoltaic panel 54). The second photovoltaic panel 54 is electrically connected with the DC coupling terminal 33 of the hydrogen generation power supply device 3c.

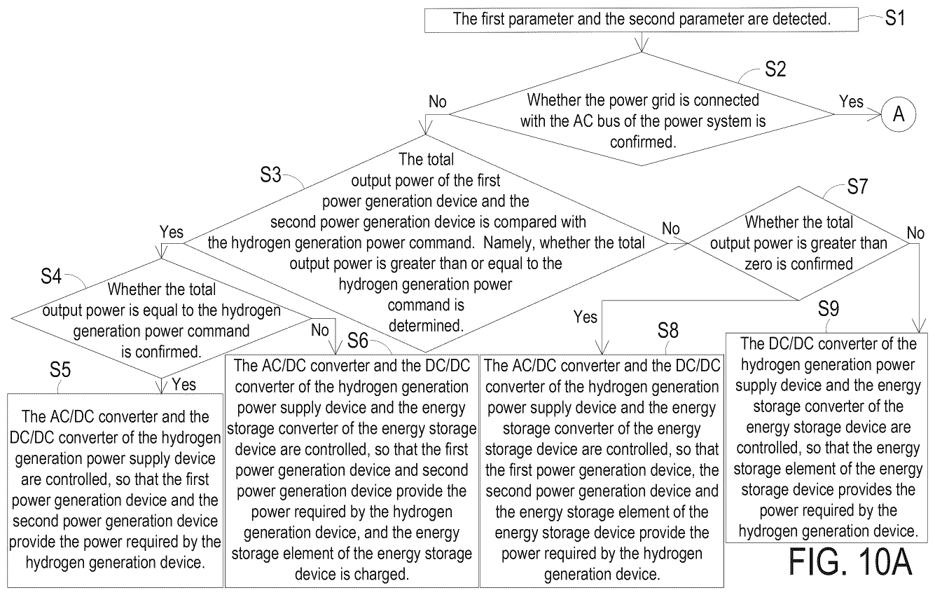

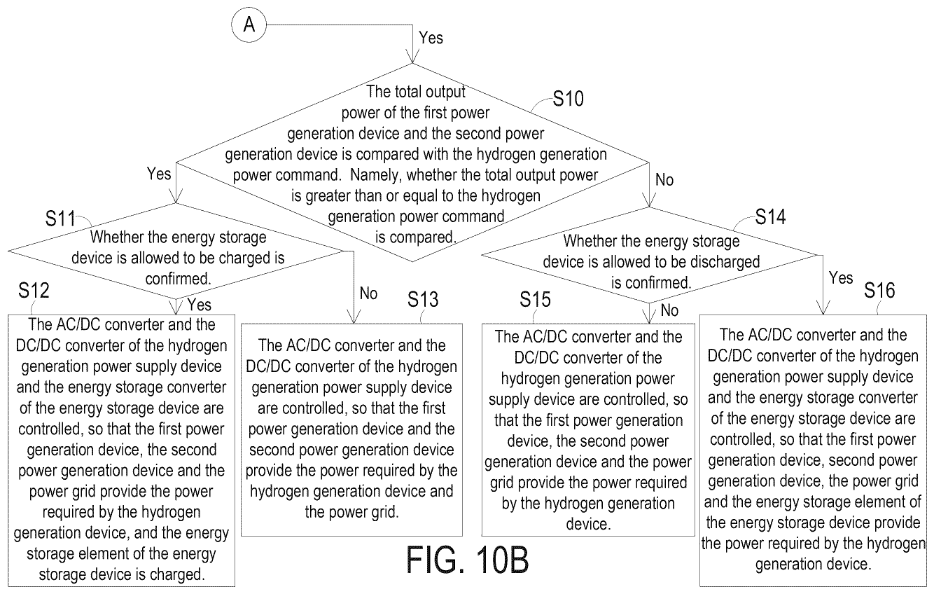

FIGS. 10A and 10A are flowcharts of a control method for a power system of the present disclosure. A step S1 is performed. In the step S1, the first parameter and the second parameter are detected. The first parameter may include the grid signal of the power grid 21, the output power signal of the first power generation device 2a, the output power signal of the second power generation device 2b, the state signal and the hydrogen generation power command of the hydrogen generation device 4. The second parameter may include parameters of the power transmission path. A step S2 is performed. In the step S2, whether the power grid 21 is connected with the AC bus 20 of the power system 1 is confirmed. If the confirming result of the step S2 is not satisfied, the power grid 21 is not connected with the AC bus 20 of the power system 1 (i.e., under the off-grid condition), and a step S3 is performed. In the step S3, the total output power of the first power generation device 2a and the second power generation device 2b (i.e., P_{green}=Pₚᵥ+P_{wind}) is compared with the hydrogen generation power command P_{EC}. Namely, whether the total output power P_{green} is greater than or equal to the hydrogen generation power command P_{EC} is determined. If the confirming result of the step S3 is satisfied, the total output power P_{green} is greater than or equal to the hydrogen generation power command P_{EC}, a step S4 is performed. In the step S4, whether the total output power P_{green} is equal to the hydrogen generation power command P_{EC} is confirmed. If the confirming result of the step S4 is satisfied, the total output power P_{green} IS equal to the hydrogen generation power command P_{EC}, a step S5 is performed. In the step S5, the AC/DC converter 34 and the DC/DC converter 35 of the hydrogen generation power supply device 3 are controlled, so that the first power generation device 2a and the second power generation device 2b provide the power required by the hydrogen generation device 4. If the confirming result of the step S4 is not satisfied, the total output power P_{green} is greater than the hydrogen generation power command P_{EC}, a step S6 is performed. In the step S6, the AC/DC converter 34 and the DC/DC converter 35 of the hydrogen generation power supply device 3 and the energy storage converter 51 of the energy storage device 5 are controlled, so that the first power generation device 2a and the second power generation device 2b provide the power required by the hydrogen generation device 4, and the energy storage element 52 of the energy storage device 5 is charged. If the confirming result of the step S3 is not satisfied, the total output power P_{green} is less than the hydrogen generation power command P_{EC}, a step S7 is performed. In the step S7, whether the total output power P_{green} is greater than zero is confirmed. If the confirming result of the step S7 is satisfied, the total output power P_{green} is greater than zero, and a step S8 is performed. In the step S8, the AC/DC converter 34 and the DC/DC converter 35 of the hydrogen generation power supply device 3 and the energy storage converter 51 of the energy storage device 5 are controlled, so that the first power generation device 2a, the second power generation device 2b and the energy storage element 52 of the energy storage device 5 provide the power required by the hydrogen generation device 4. If the confirming result of the step S7 is not satisfied, the total output power P_{green} is equal to zero, and a step S9 is performed. In the step S9, the DC/DC converter 35 of the hydrogen generation power supply device 3 and the energy storage converter 51 of the energy storage device are controlled, so that the energy storage element 52 of the energy storage device 5 provides the power required by the hydrogen generation device 4. If the confirming result of the step S2 is satisfied, the power grid 21 is connected with the AC bus 20 of the power system 1 (i.e., under the grid-connected condition), and a step S10 is performed. In the step S10, the total output power of the first power generation device 2a and the second power generation device 2b (i.e., P_{green}=Pₚᵥ+P_{wind}) is compared with the hydrogen generation power command P_{EC}. Namely, whether the total output power P_{green} is greater than or equal to the hydrogen generation power command P_{EC} is compared. If the confirming result of the step S10 is satisfied, the total output power P_{green} is greater than or equal to the hydrogen generation power command P_{EC}, and a step S11 is performed. In the step S11, whether the energy storage device 5 is allowed to be charged is confirmed. If the confirming result of the step S11 is satisfied, the energy storage device 5 is allowed to be charged, and a step S12 is performed. In the step S12, the AC/DC converter 34 and the DC/DC converter 35 of the hydrogen generation power supply device 3 and the energy storage converter 51 of the energy storage device 5 are controlled, so that the first power generation device 2a, the second power generation device 2b and the power grid 21 provide the power required by the hydrogen generation device 4, and the energy storage element 52 of the energy storage device 5 is charged. If the confirming result of the step S11 is not satisfied, the energy storage device 5 is not allowed to be charged, and a step S13 is performed. In the step S13, the AC/DC converter 34 and the DC/DC converter 35 of the hydrogen generation power supply device 3 are controlled, so that the first power generation device 2a and the second power generation device 2b provide the power required by the hydrogen generation device 4 and the power grid 21. If the confirming result of the step S10 is not satisfied, the total output power P_{green} is less than the hydrogen generation power command P_{EC}, and a step S14 is performed. In the step S14, whether the energy storage device 5 is allowed to be discharged is confirmed. If the confirming result of the step S14 is not satisfied, the energy storage device 5 is not allowed to be discharged, and a step S15 is performed. In the step S15, the AC/DC converter 34 and the DC/DC converter 35 of the hydrogen generation power supply device 3 are controlled, so that the first power generation device 2a, the second power generation device 2b and the power grid 21 provide the power required by the hydrogen generation device 4. If the confirming result of the step S14 is satisfied, the energy storage device 5 is allowed to be discharged, and a step S16 is performed. In the step S16, the AC/DC converter 34 and the DC/DC converter 35 of the hydrogen generation power supply device 3 and the energy storage converter 51 of the energy storage device 5 are controlled, so that the first power generation device 2a, second power generation device 2b, the power grid 21 and the energy storage element 52 of the energy storage device 5 provide the power required by the hydrogen generation device 4. Namely, the power system of the present disclosure selects the power source providing the hydrogen generation device according to the confirming result of the steps S2, S3, S10, S11 and S13.

In is noted that the steps of the above methods are merely exemplary. When the architecture, the application scenario, or the design requirements change, one or more of the steps may be correspondingly adjusted. For example, the output power of the first power generation device 2a and the second power generation device 2b is relatively enhanced, the energy storage element 52 is not allowed to be charged, and the power grid 21 is not allowed to provide grid-connected power or the power grid 21 is in the off-grid state. Power limitation may be applied to the first power generation device 2a and the second power generation device 2b so as to reduce the actual output power of the first power generation device 2a and the second power generation device 2b.

According to the above control method, the minimum power provided by the energy storage device 5 should be greater than the minimum power required by the hydrogen generation device 4. For example, the minimum power provided by the energy storage device 5 is 20% of the rated power Pr of the hydrogen generation device 4, i.e., 0.2Pr. Consequently, when the electric power supplied by the wind converter 22 of the first power generation device 2a, the photovoltaic inverter 23 of the second power generation device 2b or the power grid 21 are suddenly interrupted, the electric power provided by the energy storage device 5 supports the hydrogen generation device 4 continuously at the minimum power. Then, the wind converter 22 of the first power generation device 2a, the photovoltaic inverter 23 of the second power generation device 2b or the power grid 21 resumes to supply power. The maximum power provided by the energy storage device 5 may be equal to the maximum power of the hydrogen generation device 4. For example, the maximum power provided by the energy storage device 5 is 110% of the rated power Pr, i.e., 1.1Pr. Consequently, the hydrogen generation device 4 generates hydrogen rapidly. In an embodiment, the capacity of the energy storage device 5 can be adjusted according to the actual hydrogen generation and the interruption duration of the electric power provided by the wind converter 22 of the first power generation device 2a and the photovoltaic inverter 23 of the second power generation device 2b. The power system of the present disclosure can achieve energy scheduling under different modes according to the above control methods, so that the hydrogen generation device 4 can be maintained at an efficient operating condition. Alternatively, the power system of the present disclosure can maintain hydrogen generation at the minimum power required by the hydrogen generation device 4 under completely dark conditions. Consequently, the hydrogen generation efficiency and hydrogen purity of the hydrogen generation device 4 is ensured. In an embodiment, the power system of the present disclosure is switched to an appropriate mode for hydrogen generation according to the real-time electricity price of the power grid 21 and the cost of the energy storage device 5. Consequently, the cost of hydrogen generation is reduced.

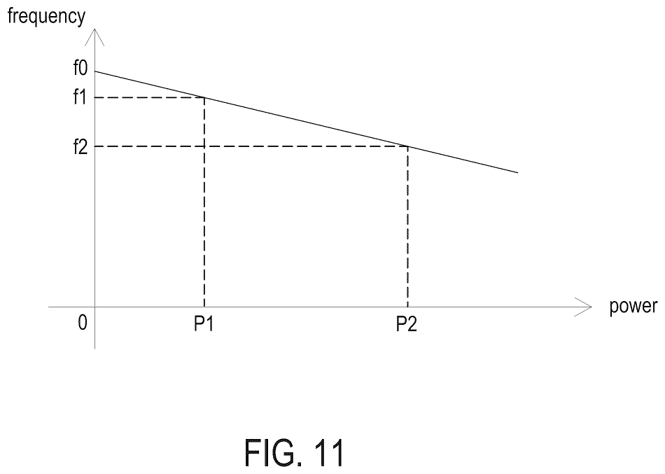

In this embodiment, the power system is communicated with the wind converter 22 of the first power generation device 2a and/or the photovoltaic inverter 23 of the second power generation device 2b through three methods. The first communication method is fast field-station communication through interconnection wire. The power system is communicated with the wind converter 22 of the first power generation device 2a and/or the photovoltaic inverter 23 of the second power generation device 2b through communication cables. The second communication method is power line carrier communication. The transmitting side between the power system and the wind converter 22 of the first power generation device 2a and/or the photovoltaic inverter 23 of the second power generation device 2b modulates communication data into high-frequency signals and loads the signals onto the power wire. The receiving side between the power system and the wind converter 22 of the first power generation device 2a and/or the photovoltaic inverter 23 of the second power generation device 2b demodulates and separates the high-frequency communication data. The third communication method is the power system utilizing the AC/DC converter 34 to adjust the frequency of the bus voltage of the AC bus 20 according to the power required by the hydrogen generation device 4. Consequently, when the wind converter 22 of the first power generation device 2a and/or the photovoltaic inverter 23 of the second power generation device 2b detect a frequency change of the bus voltage of the AC bus 20, the electric power supplied to the AC bus 20 is adjusted according to the corresponding frequency-power relationship. The relationship between the power of the wind converter 22 of the first power generation device 2a and/or the photovoltaic inverter 23 of the second power generation device 2b and the frequency of the bus voltage of the AC bus 20 is shown in FIG. 11. When the power system adopts the third communication method, no additional interconnection wires are required, and only the original power transmission wired are utilized. Consequently, the cost and the difficulty of regulation are reduced, and the implementation convenience is enhanced.

From the above descriptions, the present disclosure provides a power system and a control method of the power system. The power system determines the operating mode according to the states and parameters of one or more of the power sources, the energy storage device and the hydrogen generation device. The power source and the corresponding power transmission path for hydrogen generation is selected. The selected power source supplies power. The selected power is converted and transmitted to provide the electric power required by the hydrogen generation device through the selected power transmission path. The selected optimal power source and the power transmission path supply power to the hydrogen generation device with stable, continuous, enhanced efficiency and reduced cost.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power system suppling a hydrogen generation device, and the power system comprising:
a plurality of power sources;
an energy storage device; and
a hydrogen generation power supply device comprising an AC terminal, a DC output terminal, a DC coupling terminal and a controller, wherein the AC terminal is electrically connected with the plurality of power sources through an AC bus, the DC output terminal is electrically connected with the hydrogen generation device, the DC coupling terminal is electrically connected with the energy storage device, wherein the controller determines an operating mode according to states and parameters of the plurality of power sources, the energy storage device and/or the hydrogen generation device, and the controller selectively receives and converts an electric power provided by at least one of the plurality of power sources and/or the energy storage device, so as to supply power to the hydrogen generation device through at least one power transmission path;
wherein the hydrogen generation power supply device and/or the energy storage device provide the at least one power transmission path.

2. The power system according to claim 1, wherein a plurality of power transmission paths are formed between the plurality of power sources and the hydrogen generation device, and each of the plurality of power transmission paths comprises at least one power converter, and the at least one power converter is configured to perform power conversion and transmission in the corresponding power transmission path.

3. The power system according to claim 2, wherein the controller comprises:
a mode selection unit electrically connected with the plurality of power sources and the hydrogen generation device, wherein the mode selection unit is configured to receive a plurality of first parameters, determine power sources for supplying power to the hydrogen generation device according to the plurality of first parameters, and generate a plurality of power commands; and
a plurality of power control units, wherein each of the power control units is electrically connected with the mode selection unit, a corresponding power transmission path and a corresponding power converter, wherein each of the power control units is configured to receive a plurality of second parameters and at least one of the plurality of power commands, and control the corresponding power converter according to the plurality of second parameters and the at least one of the plurality of power commands, so that the corresponding power transmission path supplies power to the hydrogen generation device.

4. The power system according to claim 3, wherein the plurality of first parameters comprises power parameters of the plurality of power sources and the hydrogen generation device, and the plurality of second parameters comprises power parameters of the plurality of power transmission paths.

5. The power system according to claim 3, wherein the plurality of power sources comprise a first power generation device, a second power generation device and a power grid, wherein the first power generation device, the second power generation device and the power grid are electrically connected with the AC bus, respectively.

6. The power system according to claim 5, wherein the mode selection unit is configured to receive an output power signal of the first power generation device, an output power signal of the second power generation device, a state signal of the hydrogen generation device, a grid signal of the power grid, and/or a hydrogen generation power command; determine a grid state according to the grid signal; compare a total output power of the first power generation device and the second power generation device with the hydrogen generation power command to obtain a comparing result; and select at least one of the plurality of power sources according to the grid state and the comparing result.

7. The power system according to claim 6, wherein the hydrogen generation power supply device comprises an AC/DC converter and a DC/DC converter, the AC/DC converter is electrically connected with the AC terminal, the DC/DC converter is electrically connected between the AC/DC converter and the DC output terminal, the AC/DC converter and the DC/DC converter are electrically connected with the DC coupling terminal, wherein the energy storage device comprises an energy storage converter and an energy storage element, and the energy storage converter is electrically connected between the DC coupling terminal and the energy storage element.

8. The power system according to claim 6, wherein the hydrogen generation power supply device comprises an AC/DC converter, the AC/DC converter being electrically connected between the AC terminal and the DC coupling terminal, and the energy storage device comprises an energy storage converter and an energy storage element, the energy storage converter being electrically connected between the DC coupling terminal and the energy storage element.

9. The power system according to claim 7, wherein the energy storage device further comprises an additional energy storage converter and a photovoltaic element, and the additional energy storage converter is electrically connected between the DC coupling terminal and the photovoltaic element.

10. The power system according to claim 7, wherein the plurality of power control units comprise:
an AC/DC control unit configured to receive at least one of the plurality of power commands, an AC voltage and an AC current of the AC terminal, and/or a DC bus voltage of the DC coupling terminal, and output a first control signal to control the AC/DC converter;
a DC/DC control unit configured to receive at least one of the plurality of power commands, an output voltage and/or an output current of the DC output terminal, and output a second control signal to control the DC/DC converter; and
an energy storage control unit configured to receive a voltage and a current of the energy storage element, and/or the DC bus voltage of the DC coupling terminal, and output a third control signal to control the energy storage converter.

11. The power system according to claim 6, wherein when the mode selection unit determines that the power grid is not connected with the AC bus, and the total output power of the first power generation device and the second power generation device is equal to the hydrogen generation power command, the mode selection unit selects the first power generation device and the second power generation device to provide an electric power required by the hydrogen generation device;
wherein when the mode selection unit determines that the power grid is not connected with the AC bus, and the total output power of the first power generation device and the second power generation device is greater than the hydrogen generation power command, the mode selection unit selects the first power generation device and the second power generation device to provide the electric power required by the hydrogen generation device, and to charge an energy storage element of the energy storage device simultaneously;
wherein when the mode selection unit determines that the power grid is not connected with the AC bus, the total output power of the first power generation device and the second power generation device is less than the hydrogen generation power command, and the total output power is greater than 0, the mode selection unit selects the first power generation device, the second power generation device and the energy storage device to provide the electric power required by the hydrogen generation device; and
wherein when the mode selection unit determines that the power grid is not connected with the AC bus, and the total output power of the first power generation device and the second power generation device is equal to 0, the mode selection unit selects the energy storage device to provide the electric power required by the hydrogen generation device.

12. The power system according to claim 6, wherein when the mode selection unit determines that the power grid is electrically connected with the AC bus, the total output power of the first power generation device and the second power generation device is greater than or equal to the hydrogen generation power command, and the energy storage device is allowed to be charged, the mode selection unit selects the first power generation device, the second power generation device and the power grid to provide an electric power required by the hydrogen generation device, and to charge an energy storage element of the energy storage device simultaneously;
wherein when the mode selection unit determines that the power grid is electrically connected with the AC bus, the total output power of the first power generation device and the second power generation device is greater than or equal to the hydrogen generation power command, and the energy storage device is not allowed to be charged, the mode selection unit selects the first power generation device and the second power generation device to provide an first electric power required by the hydrogen generation device, and an second electric power to the power grid simultaneously;
wherein when the mode selection unit determines that the power grid is electrically connected with the AC bus, the total output power of the first power generation device and the second power generation device is less than the hydrogen generation power command, and the energy storage device is not allowed to be discharged, the mode selection unit selects the first power generation device, the second power generation device and the power grid to provide the electric power required by the hydrogen generation device; and
wherein when the mode selection unit determines that the power grid is electrically connected with the AC bus, the total output power of the first power generation device and the second power generation device is less than the hydrogen generation power command, and the energy storage device is allowed to be discharged, the mode selection unit selects the first power generation device, the second power generation device, the power grid and the energy storage device to provide the electric power required by the hydrogen generation device.

13. The power system according to claim 1, wherein when a total output power of the plurality of power sources is less than a hydrogen generation power command of the hydrogen generation device, the hydrogen generation power supply device and the energy storage device provide a plurality of power transmission paths to supply power to the hydrogen generation device collaboratively; and when the total output power of the plurality of power sources is greater than or equal to the hydrogen generation power command of the hydrogen generation device, the hydrogen generation power supply device provides the at least one power transmission path to supply power to the hydrogen generation device.

14. A DC coupling device, comprising:
an energy storage device; and
a power supply device comprising an AC terminal, a DC output terminal, a DC coupling terminal and a controller, wherein the AC terminal is electrically connected with at least one power source through an AC bus, the DC output terminal is electrically connected with a power load, and the DC coupling terminal is electrically connected with the energy storage device;
wherein the controller determines an operating mode according to states and parameters of the at least one power source, the energy storage device and/or the power load, and selectively receives and converts an electric power provided by the at least one power source and/or the energy storage device so as to supply power to the power load through at least one power transmission path;
wherein the power supply device and/or the energy storage device provide the at least one power transmission path.

15. The DC coupling device according to claim 14, wherein a plurality of power transmission paths are formed between the at least one power source and the power load, each of the plurality of power transmission paths comprises at least one power converter, the at least one power converter is configured to convert and transmit power in the corresponding power transmission path.

16. The DC coupling device according to claim 15, wherein the controller comprises:
a mode selection unit electrically connected with the at least one power source and the power load, and configured to receive a plurality of first parameters, determine the at least one power source supplying the power load according to the plurality of first parameters, and generate a plurality of power commands; and
a plurality of power control units, wherein each of the plurality of power control units is electrically connected with the mode selection unit, the corresponding power transmission path and the corresponding power converter, and configured to receive a plurality of second parameters and at least one of the plurality of power commands, and control the corresponding power converter according to the plurality of second parameters and the at least one of plurality of power commands, so that the corresponding power transmission path provides power to the power load.

17. The DC coupling device according to claim 16, wherein the plurality of first parameters comprises power parameters of the at least one power source and the power supply device, and the plurality of second parameters comprises power parameters of the plurality of power transmission paths.

18. The DC coupling device according to claim 16, wherein the power supply device comprises an AC/DC converter and a DC/DC converter, the AC/DC converter is electrically connected with the AC terminal, the DC/DC converter is electrically connected between the AC/DC converter and the DC output terminal, the AC/DC converter and the DC/DC converter is electrically connected with the DC coupling terminal, the energy storage device comprises an energy storage converter and an energy storage element, and the energy storage converter is electrically connected between the DC coupling terminal and the energy storage element.

19. The DC coupling device according to claim 16, wherein the power supply device comprises an AC/DC converter, the AC/DC converter is electrically connected between the AC terminal and the DC coupling terminal, the energy storage device comprises an energy storage converter and an energy storage element, and the energy storage converter is electrically connected between the DC coupling terminal and the energy storage element.

20. The DC coupling device according to claim 14, wherein when a total output power of the at least one power source is less than a power command of the power load, the power supply device and the energy storage device provide a plurality of power transmission paths to supply power to the power load collaboratively; and when the total output power of the at least one power source is greater than or equal to the power command of the power load, the power supply device provides the at least one power transmission path to supply power to the power load.

21. A control method applied to a power system, the power system suppling power to a hydrogen generation device, the control method comprising:
(a) providing a plurality of power sources, an energy storage device and a hydrogen generation power supply device, the hydrogen generation power supply device comprising an AC terminal, a DC output terminal and a DC coupling terminal, wherein the AC terminal is electrically connected with the plurality of power sources through an AC bus, the DC output terminal is electrically connected with the hydrogen generation device, and the DC coupling terminal is electrically connected with the energy storage device; and
(b) determining an operating mode according to states and parameters of the plurality of power sources, the energy storage device and/or the hydrogen generation device, and selectively receiving and converting an electric power provided by at least one of the plurality of power sources and/or the energy storage device so as to supply power to the hydrogen generation device through at least one power transmission path;
wherein the power supply device and/or the energy storage device provide the at least one power transmission path.

22. The control method according to claim 21, wherein the plurality of power sources comprise a power grid, a first power generation device and a second power generation device, and the step (b) further comprises:
(b1) confirming whether the power grid is connected with the AC bus;
(b2) comparing a total output power of the first power generation device and the second power generation device with a hydrogen generation power command; and
(b3) selecting a power source to supply power to the hydrogen generation device according to a confirming result of the step (b1) and a comparing result of the step (b2).

23. The control method according to claim 22, wherein when the confirming result of the step (b1) is not satisfied, and the comparing result of the step (b2) is that the total output power is equal to the hydrogen generation power command, select the first power generation device and the second power generation device to provide power required by the hydrogen generation device;
wherein when the confirming result of the step (b1) is not satisfied, and the comparing result of the step (b2) is that the total output power is greater than the hydrogen generation power command, select the first power generation device and the second power generation device to provide the power required by the hydrogen generation device, and to charge an energy storage element of the energy storage device simultaneously;
wherein when the confirming result of the step (b1) is not satisfied, and the comparing result of the step (b2) is that the total output power is less than the hydrogen generation power command and the total output power is greater than 0, select the first power generation device, the second power generation device and the energy storage device to provide power required by the hydrogen generation device; and
wherein when the confirming result of the step (b1) is not satisfied, and the comparing result of the step (b2) is that the total output power is equal to 0, select the energy storage device to provide the power required by the hydrogen generation device.

24. The control method according to claim 22, wherein the step (b) further comprises a step (b4), confirming whether the energy storage device is allowed to be charged and discharged, and wherein the step (b3) further selects a power source to supply power to the hydrogen generation device according to the confirming result of the step (b1), the comparing result of the step (b2) and the confirming result of the step (b4).

25. The control method according to claim 24, wherein when the confirming result of step (b1) is satisfied, the comparing result of the step (b2) is that the total output power is greater than or equal to the hydrogen generation power command, and the confirming result of the step (b4) is that the energy storage device is allowed to charged, select the first power generation device, the second power generation device and the power grid to provide power required by the hydrogen generation device, and to charge an energy storage element of the energy storage device simultaneously;
wherein when the confirming result of the step (b1) is satisfied, the comparing result of the step (b2) is that the total output power is greater than or equal to the hydrogen generation power command, and the confirming result of the step (b4) is that the energy storage device is not allowed to be charged, select the first power generation device and the second power generation device to provide the power required by the hydrogen generation device, and to charge the power grid simultaneously;
wherein when the confirming result of the step (b1) is satisfies, the comparing result of the step (b2) is that the total output power is less than the hydrogen generation power command, and the confirming result of the step (b4) is that the energy storage device is not allowed to be discharged, select the first power generation device, the second power generation device and the power grid to provide the power required by the hydrogen generation device; and
wherein when the confirming result of the step (b1) is satisfies, the comparing result of the step (b2) is that the total output power is less than the hydrogen generation power command, and the confirming result of the step (b4) is that the energy storage device is allowed to be discharged, select the first power generation device, the second power generation device, the power grid and the energy storage device to provide the power required by the hydrogen generation device simultaneously.
